(19) United States
(12) Patent Application Publication
(10) Pub. No.: US 2005/0173571 A1
(43) Pub. Date: Aug. 11, 2005

(54) Household bean milk and bean curd maker with steam discharge function

(76) Inventor: Hong-bae Kim, Koyang-city (KR)

Correspondence Address: SHLESINGER, ARKWRIGHT & GARVEY LLP;Suite 600, 1420 King Street, Alexandria, VA, 22314, US

(21) Appl. No.: 10/960,751

(22) Filed: Oct. 8, 2004

(30) Foreign Application Priority Data
Oct. 8, 2003 (KR) 2003-31677

(51) Int. Cl. A23L 1/00

(52) U.S. Cl. 241/92; 99/348

(57) ABSTRACT

Disclosed herein is a household bean milk and bean curd maker with a steam discharge function. The maker includes a housing defining a cavity therein, and a main body provided on an upper portion of the housing to open or close the housing. The maker further includes a steam outlet path provided in the main body to connect the cavity of the housing to the outside. Thus, according to the present invention, the maker is constructed so that the steam outlet path, which connects the cavity of the housing to the outside, is provided in the main body, thus allowing steam produced in the housing to be efficiently discharged through the steam outlet path to the outside.

### CROSS-REFERENCE OF RELATED APPLICATIONS

This application claims priority of Korean application no. 2003-31677, filed Oct. 8, 2003, which is incorporated herein by reference.

This application relates to Applicant's concurrently filed U.S. application (applicant's ref. no. 7398), entitled “AIR VENT UNIT FOR HOUSEHOLD BEAN MILK AND BEAN CURD MAKERS”, filed Oct. 8, 2004.

### FIELD OF THE INVENTION

The present invention relates generally to household bean milk and bean curd makers and, more particularly, to a household bean milk and bean curd maker with a steam discharge function, which is constructed so that a steam outlet path connecting a cavity of a housing to the outside is provided in a main body, thus allowing steam produced in the housing to be discharged through the steam outlet path to the outside.

### BACKGROUND OF THE INVENTION

A conventional method of making bean milk and bean curd has a problem in that several processes are individually executed, thus it is inconvenient and complicated to make bean milk and bean curd, and it takes longer time to make the bean milk and the bean curd, thereby the conventional method is inefficient.

In order to solve the problems, there have been proposed various devices for easily and conveniently making bean milk and bean curd at home. For example, there are Korean Patent No. 225772, Korean Patent No. 228659, Korean U.M. Registration No. 158856, Korean U.M. Registration No. 250843, etc, that are disclosed by the applicant of the present invention. The Korean Patent No. 225772 was published on Oct. 15, 1999, and is titled “household bean curd maker”. The Korean Patent No. 2000-228659 was published on Mar. 15, 2000, and is titled “household bean curd maker”. The Korean U.M. Registration No. 158856 was registered on Jul. 16, 1999, and is titled “household bean curd maker”. The Korean U.M. Registration No. 250843 was registered on Oct. 5, 2001, and is titled “household bean curd maker with fixed-type blade unit”.

A conventional household bean milk and bean curd maker will be described in the following with reference to the attached drawing.

FIG. 1 is a sectional view of the conventional household bean milk and bean curd maker. As shown in FIG. 1, the conventional household bean milk and bean curd maker includes a housing 1 which has a cavity to contain water therein. A main body 2 is provided on an upper portion of the housing 1 to open or close the housing 1, like a lid. A drive motor 3 is installed in a predetermined portion of the main body 2, and generates rotating power when electricity is applied to the drive motor 3. A drive shaft 4 transmits the rotating power from the drive motor 3. A cutting blade 5 is provided at an end of the drive shaft 4. A rod-shaped heater 6 downwardly extends from the main body 2, and generates heat when electricity is applied to the heater 6, thus heating an interior of the housing 1. A temperature sensing bar 7 detects the temperature of the interior of the housing 1. A filter net 8 is detachably mounted to a predetermined portion of the main body 2, and contains beans therein.

The conventional household bean milk and bean curd maker constructed as described above is operated as follows.

First, a user puts water into the housing 1. Beans are put into the filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate the heater 6 and the temperature sensing bar 7. At this time, a primary heating process is executed while maintaining a predetermined temperature, for a predetermined period.

When the primary heating process has been completed, the control unit (not shown) outputs a control signal to operate the drive motor 3. As the drive motor 3 is operated, the beans contained in the filter net 8 are ground by the cutting blade 5 provided at the end of the drive shaft 4. While the beans are ground, turbulence of water contained in the housing 1 is caused by rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

However, the conventional household bean milk and bean curd maker is problematic in that the maker cannot efficiently discharge a large quantity of steam, produced during the heating process, to the outside.

### OBJECTS AND SUMMARY OF THE INVENTION

Accordingly, the present invention has been made keeping in mind the above problems occurring in the prior art, and an object of the present invention is to provide a household bean milk and bean curd maker with a steam discharge function, which is constructed so that a steam outlet path connecting a cavity of a housing to the outside is provided in a main body, thus allowing steam produced in the housing to be discharged through the steam outlet path to the outside.

### BRIEF DESCRIPTION OF THE DRAWINGS

FIG. 1 is a sectional view of a conventional household bean milk and bean curd maker;

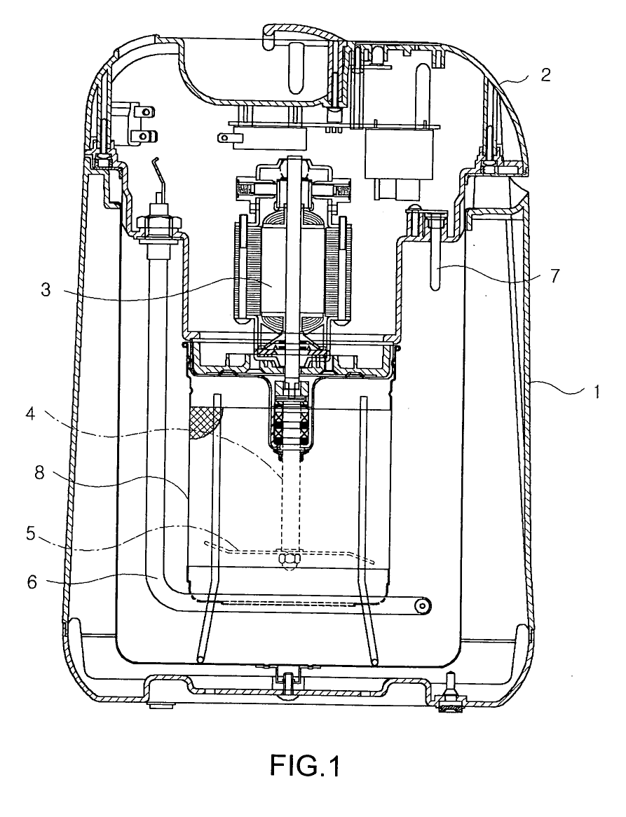

FIG. 2 is a sectional view of a household bean milk and bean curd maker with a steam discharge function, according to the first embodiment of the present invention; and

FIG. 3 is a sectional view of a household bean milk and bean curd maker with a steam discharge function, according to the second embodiment of the present invention.

### DETAILED DESCRIPTION OF THE INVENTION

Hereinafter, preferred embodiments of the present invention will be described in detail with reference to the attached drawings so that those skilled in the art may easily implement this invention. The above and other objects, features and other advantages of the present invention will be more clearly understood from the following detailed description.

Since the preferred embodiments of the present invention have been disclosed for illustrative purposes, those skilled in the art will appreciate that various modifications, additions and substitutions are possible, without departing from the scope and spirit of the invention as disclosed in the accompanying claims.

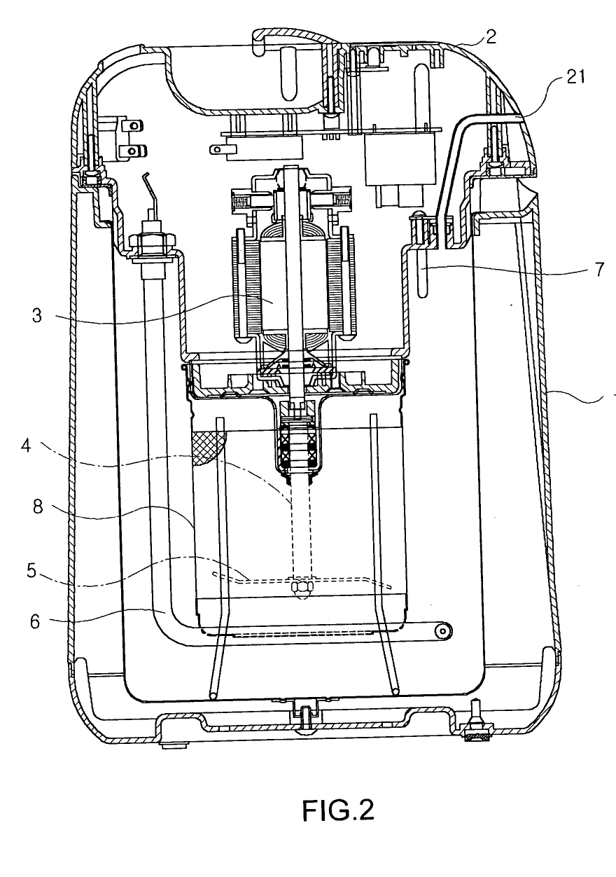

A household bean milk and bean curd maker with a steam discharge function, according to the first embodiment of the present invention, is constructed as follows. As shown in FIG. 2, the household bean milk and bean curd maker includes a housing 1 and a main body 2. The housing 1 has a cavity therein. The main body 2 is provided on an upper portion of the housing 1 to open or close the housing 1, like a lid. Further, the household bean milk and bean curd maker includes a steam outlet path 21. The steam outlet path 21 is provided in the main body 2 to connect the cavity of the housing 1 to the outside.

The household bean milk and bean curd maker with the steam discharge function constructed as described above is operated as follows.

First, a user puts water into the housing 1. Beans are put into a filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate a heater 6 and a temperature sensing bar 7. At this time, a primary heating process is executed while maintaining a predetermined temperature, for a predetermined period.

When the primary heating process has been completed, the control unit (not shown) outputs a control signal to operate a drive motor 3. As the drive motor 3 is operated, the beans contained in the filter net 8 are ground by a cutting blade 5 provided at the end of a drive shaft 4. While the beans are ground, turbulence of water contained in the housing 1 is caused by the rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

In the process of making the bean milk or bean curd, a large quantity of steam is produced in the housing 1 during the primary and secondary heating operations. The steam is rapidly discharged through the steam outlet path 21 provided in the main body 2 to the outside, thus allowing the making process to be efficiently performed.

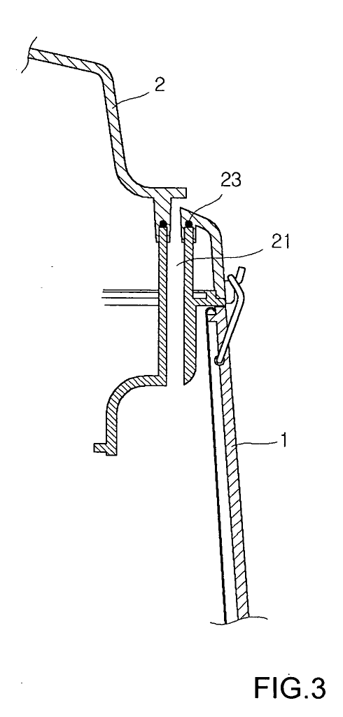

Meanwhile, a household bean milk and bean curd maker with a steam discharge function according to the second embodiment is constructed as follows. As shown in FIG. 3, the household bean milk and bean curd maker includes a housing 1 and a main body 2. The housing 1 has a cavity therein. The main body 2 is provided on an upper portion of the housing 1 to open or close the housing 1, like a lid. Further, a steam outlet path 21 is provided in the main body 2 to connect the cavity of the housing 1 to the outside. According to the second embodiment, the steam outlet path 21 includes a connected part, and an O-ring 23 is mounted in the connected part of the steam outlet path 21.

The general construction of the household bean milk and bean curd maker with the steam discharge function of the second embodiment remains the same as that of the first embodiment shown in FIG. 2, except that the steam outlet path 21 has the connected part and the O-ring 23 is mounted in the connected part of the steam outlet path 21, thus maximally preventing steam from flowing into the main body 2. Thus, the operation of the household bean milk and bean curd maker with the steam discharge function according to the second embodiment will be omitted herein.

As described above, the present invention is to provide a household bean milk and bean curd maker with a steam discharge function, which is constructed so that a steam outlet path, which connects a cavity of a housing to the outside, is provided in a main body, thus allowing steam produced in the housing to be efficiently discharged through the steam outlet path to the outside.

While this invention has been described as having a preferred design, it is understood that it is capable of further modifications, and uses and/or adaptations of the invention and including such departures from the present disclosure as come within the known customary practice in the art to which the invention pertains, and as may be applied to the central features hereinbefore set forth, and fall within the scope of the invention or limits of the claims appended hereto.

1. A household bean milk and bean curd maker with a steam discharge function, comprising:
a) a housing defining a cavity therein;
b) a main body provided on an upper portion of the housing to open or close the housing; and
c) a steam outlet path provided in the main body to connect the cavity of the housing to an outside.

2. The household bean milk and bean curd maker as set forth in claim 1, wherein:
a) the steam outlet path comprises a connected part, with an O-ring mounted in the connected part of the steam outlet path.
